(19) United States
(12) Patent Application Publication
(10) Pub. No.: US 2012/0231122 A1
(43) Pub. Date: Sep. 13, 2012

(54) SUGAR FREE / NON-CARIOGENIC ENCAPSULATION MATRIX

(76) Inventor: Irene Tran, East Brunswick, NJ (US)

(21) Appl. No.: 13/046,493

(22) Filed: Mar. 11, 2011

(51) Int. Cl. A23L 1/035

(52) U.S. Cl. 426/103; 426/654; 426/602

(57) ABSTRACT

Provided herein are emulsifier and non-digestible carbohydrate mixtures for sugar free/non-cariogenic encapsulation applications. A multi-component matrix that provides superior performance including emulsification, viscosity, and processability for spray drying is utilized. The resulting microcapsules with high loading showed high oil retention, low surface oil, and good oxidation resistance.

### CROSS-REFERENCE TO RELATED APPLICATIONS

Not Applicable

### STATEMENT REGARDING FEDERALLY-FUNDED RESEARCH

Not Applicable

### NAMES OF THE PARTIES TO A JOINT RESEARCH AGREEMENT

Not Applicable

### SEQUENCE LISTING, TABLE OF COMPUTER REFERENCE AND INCORPORATION THEREOF

Not Applicable

### BACKGROUND OF THE INVENTION

Many applications, such as confectionary, oral care, and special diet, require using ingredients that are sugar free/non-cariogenic. Modified starches and maltodextrins are currently used as encapsulation ingredients, however they are not sugar free. Gum Arabic is a sugar-free/non-cariogenic ingredient; however it is known to have limitations on viscosity and encapsulation performance, such as oil loading, surface oil, and active oxidation.

### SUMMARY OF THE INVENTION

This invention involves the use of emulsifier and non-digestible carbohydrate mixtures for sugar free/non-cariogenic encapsulation applications. A multi-component matrix that provides superior performance including emulsification, viscosity, and processability for spray drying is utilized. The resulting microcapsules with high loading showed high oil retention, low surface oil, and good oxidation resistance. In one embodiment, an encapsulating agent comprising an emulsifier; and a non-digestible carbohydrate, wherein the non-digestible carbohydrate is selected from the group consisting of a non-digestible carbohydrate with a DP less than 13; or a mixture comprising two or more non-digestible carbohydrates, wherein at least one non-digestible carbohydrate component of the mixture has a DP of less than 13; and wherein the at least one non-digestible carbohydrate component of the mixture having a DP of less than 13 is at least 5% w/w of the mixture; and wherein the encapsulating agent results in less than 1800 ppm oxidized components when tested in a sample encapsulation of 30% w/w orange oil 1× for 14 days at 50° C.

In another embodiment, an oil-in-water emulsion of the encapsulating agent results in a Brookfield viscosity less than 150 cps at 50% solids at 22° C. when tested in a sample oil-in-water emulsion consisting of: a. 15% w/w orange oil 1×; b. 35% w/w of the encapsulating agent utilized as an emulsifier, wherein the encapsulating agent utilized as an emulsifier comprises 1.29% of the emulsifier, and 2.6% of the non-digestible carbohydrate, and c. 50.0% w/w water.

In another embodiment, the average DP of the encapsulating agent is at least 3.

In another embodiment, the emulsifier of the encapsulating agent utilized as the emulsifier is Q-NATURALE®. emulsifier.

In another embodiment, the encapsulating agent has a TDF of 60-100%.

In another embodiment, the at least one non-digestible carbohydrate component of the encapsulating agent having 60-100% TDF is further characterized as having a DP of less than 100.

In another embodiment, the emulsifier is selected from the group consisting of gum ghatti, pectin, gum arabic, modified cellulosics, lecithin, arabinogalactan, proteins, saponin, quilaja, quillaja solid extract, and/or quillaic acid, polysorbates, and sugar esters.

In another embodiment, the non-digestible carbohydrate is selected from the group consisting of gum arabic; polydextrose; short chain fructose oligosaccharide; and resistant maltodextrins.

In another embodiment, the resistant maltodextrin is selected from the group consisting of fibersol and nutriose.

In another embodiment, the non-digestible carbohydrate is further comprised of a polyol.

In another embodiment, the polyol is selected from the group consisting of erythtirol; hydrogenated starch hydrosylates; hydrogenated starch polyglycitols; isomalt; lactitol; maltitol; mannitol; sorbitol; and xylitol.

In another embodiment, the emulsifier is substantially sugar free.

In another embodiment, the emulsifier is gum arabic.

In another embodiment, the emulsifier is a saponin.

In another embodiment, the saponin is a Quillaja solid extract.

In another embodiment, the non-digestible carbohydrate is selected from the group consisting of resistant maltodextrin, polydextrose, and short chain fructose oligosaccharides.

In another embodiment, the mixture comprises two or more non-digestible carbohydrates is comprised of Gum Arabic and sorbitol.

In another embodiment, the mixture comprises two or more non-digestible carbohydrates is comprised of nutriose and sorbitol.

In another embodiment, the mixture comprises two or more non-digestible carbohydrates is comprised of nutriose and maltitol.

In another embodiment, the mixture comprises nutriose and xylitol.

In another embodiment, the mixture comprising two or more non-digestible carbohydrates is comprised of nutriose and mannitol.

In another embodiment, the mixture comprising two or more non-digestible carbohydrates is comprised of nutriose and sorbitol.

In another embodiment, the emulsifier is present in a w/w percentage of 0.5-40 of the encapsulating agent.

In another embodiment, the non-digestible carbohydrate is present in a w/w percentage of 60-99.5 of the encapsulating agent.

In another embodiment, an encapsulated product comprising (a) an encapsulating agent; and (b) an active agent.

In another embodiment, the encapsulated product is at least 30% w/w active agent.

In another embodiment, a matrix comprising an encapsulating agent, and an active agent.

In another embodiment, a food product comprising an encapsulating agent; and an active agent.

In another embodiment, an oil-in-water emulsion comprising: a. a water-containing continuous phase; b. an active agent-containing discrete phase; and

c. an encapsulating agent.

### BRIEF DESCRIPTION OF THE SEVERAL VIEWS OF THE DRAWINGS

Not Applicable

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Unless otherwise specified, all percentages expressed herein are weight/weight.

The term “Brookfield viscosity”, as used herein, is intended to mean viscosity measured in accordance with Example 4 of the instant application.

The term “DP”, as used herein, is intended to mean “degree of polymerization” and is expressed as: DP=Total MW of the polymer/MW of the monomer unit wherein the monomer unit is a mono-saccharide or hydrogenated equivalent such as sorbitol. Representative carbohydrates include, but are not limited to, sorbitol, DP=1; FIBERSOL®, DP=2-8; Gum Arabic, DP=>100; NUTRIOSE®, DP=14; LITESSE®, DP=12; Nutra Flora®, DP=2-4; maltitol, DP=2; xylitol, DP=1; and mannitol, DP=1, approximately.

The term “emulsion particle size”, as used herein, is intended to mean the analysis substantially as described under the heading “Procedure for Measurement of Emulsion Particle Size” in the instant application (Example 3).

The term “non-cariogenic”, as used herein, is intended to mean ingredients that do not contribute to the advancement of dental caries. These ingredients do not include sugars or starches.

The term “oil-in-water emulsion”, as used herein, is intended to mean an emulsion in which the oil is in the discrete phase and the water (aqueous) is the continuous phase.

The term “oil load”, as used herein, is intended to mean the targeted amount of oil present in an encapsulated product, or microcapsules, or spray dried powder, and is characterized as follows:

Oil load=[(oil amount w/w)/(oil amount w/w+encapsulant amount w/w)]×100.

The term “oil retention”, as used herein, is intended to mean oil retained by a sample as detailed in Example 6, “Procedure for Orange Oil Retention Analysis”, in the instant application.

The term “ppm of oxidized components”, as used herein, is intended to mean the parts of oxidates per million units of encapsulated product, measured using the method described in Example 5 of the instant application.

The term “polydextrose”, as used herein, is intended to mean a polysaccharide synthesized by random polymerization of glucose, sorbitol, and a suitable acid catalyst at a high temperature and partial vacuum.

The term “resistant maltodextrin”, as utilized herein, is intended to mean a polysaccharide with an average degree of polymerization between 3 and 15, at least a significant portion of which is not absorbed in the small intestine of healthy individuals. Resistant maltodextrins include without limitation NUTRIOSE® (commercially available from Roquette Freres and National Starch LLC) and FIBERSOL® (commercially available from ADM (Decatur, Ill.)

The term short-chain fructo-oligosaccharides (ScFOS) are a mixture of oligosaccharides consisting of glucose linked to fructose units (Gfₙ; n=≦4), which are not digested in the human small intestine but are fermented in the colon where they specifically promote the growth of bifidobacteria

The term “room temperature”, as used herein is intended to mean 22° C.

The term “sample encapsulation”, as used herein, is intended to mean an encapsulation prepared in accordance with Examples 1 and 2 of the instant application, stored for 14 days at 50 C, and subsequently analyzed in accordance with Example 5 of the instant application.

The term “solids percentage”, as used herein, may be calculated as follows: [(oil+all solids)/(oil+all solids+water)]×100.

The term “substantially sugar free”, as used herein, is intended to mean less than 1% sugar w/w.

### Emulsifiers

In one embodiment, an emulsifier is utilized.

The term “emulsifier”, as used herein, is intended to mean a surface-active agent that facilitates the mixing of two or more liquid substances that would separate into its component parts under normal conditions.

In one embodiment, suitable emulsifiers include, but are not limited to, gum ghatti, pectin, modified cellulosics, lecithin, arabinogalactan, proteins, saponin, polysorbates, sugar esters, quillaja, quilliaja solid extract, quilliac acid, and/or any combination thereof.

In another embodiment, the emulsifier is gum Arabic, a gum exuded by various African trees of the genus Acacia, especially A. senegal, used in the preparation of food encapsulation and beverage emulsions and the manufacture of mucilage and candies and in general as a thickener and colloidal stabilizer. It is also called acacia.

The term “saponin”, as used herein, is intended to mean amphipathic glycoside groups characterized phenomenologically by the soap-like foaming they produce when shaken in aqueous solutions, and structurally by their composition of one or more hydrophilic glycoside moieties combined with a lipophilic triterpene derivative. They are used as emulsifiers.

In another embodiment, the emulsifier is quillaja. Quillaja is a surfactant extracted from the inner bark of soap bark trees, Quillaja Saponaria Molina, an evergreen native to Chile and Peru. Containing saponins, it is often used as a substitute for soap and as an agricultural spray adjuvant. Quillaja is also used in pharmaceuticals, food products, personal care products, and fire-fighting foams.

In another embodiment, the saponin is a sapogenin glycoside isolate of Quillaja saponaria.

In another embodiment, the saponin consists essentially of quillaic acid.

The term “quillaja solid extract”, as used herein, is intended to mean the solid portion of the quillaja containing the surface-active saponin which provides the emulsification property. The term quillaja solid extract is not intended to mean liquid quillaja extract which contains the solid portion and water.

The term “quillaja”, as used herein, is intended to mean surfactant extracted from the inner bark of soap bark trees, Quillaja Saponaria Molina, an evergreen native to Chile and Peru. Quillaja surfactant contains saponins.

### Non-Digestible Carbohydrates

The term “non-digestible carbohydrate”, as used herein, is intended to mean a carbohydrate with a total dietary fiber (“TDF”) content of at least 60%.

Suitable non-digestible carbohydrates include, but are not limited to gum arabic; Nutra Flora®; LITESSE II®; resistant maltodextrins such as FIBERSOL® and NUTRIOSE®; and polyols.

In another embodiment, the non-digestible carbohydrate is comprised of a mixture comprising at least two non-digestible carbohydrates, wherein at least one non-digestible carbohydrate component of the mixture has a DP of less than 13.

The term “polyol,” as used herein, is intended to mean a type of non-digestible carbohydrate that (1) has a DP of 2 or less; (2) is an alcohol; and (3) is non-cariogenic. Suitable polyols include, but are not limited to, erythritol; hydrogenated starch hydrosylates or polyglycitols (including maltitol syrups); isomalt; lactitol; maltitol; mannitol; sorbitol; and xylitol.

In another embodiment, the non-digestible carbohydrate is further comprised of a resistant maltodextrin.

In another embodiment, the non-digestible carbohydrate is NUTRIOSE®, a partially hydrolyzed wheat and maize starch derivative which contains up to 85% fiber. This high fiber content makes it possible to increase the digestive tolerance, to improve calorie control, to extend energy release and to obtain a lower sugar content.

In another embodiment, the non-digestible carbohydrate is further comprised of NUTRIOSE®, and has an DP of about 14.

In another embodiment, the non-digestible carbohydrate is further comprised of FIBERSOL®, a resistant maltodextrin that is a spray-dried powder produced by a controlled enzymatic hydrolysis of cornstarch.

In another embodiment, the non-digestible carbohydrate is comprised of a polydextrose.

In another embodiment, the non-digestible carbohydrate is further comprised of LITESSE®, and has an DP of about 12.

In another embodiment, the non-digestible carbohydrate is further comprised of a short-chain fructooligosaccharide (scFOS).

In another embodiment, the non-digestible carbohydrate is further comprised of Nutra Flora®, and has an average DP of about 2-4

In another embodiment, the non-digestible carbohydrate is present in a w/w percentage of 40 to 99.5%, in one embodiment 50 to 99% of the encapsulating agent.

### Total Dietary Fiber

The term “TDF” or “total dietary fiber”, as used herein, is defined as measured by AOAC method 2001.03.

In one embodiment, the TDF of the encapsulating agent is between 60%-100% TDF.

In another embodiment, the TDF of the encapsulating agent is between about 60%-about 100% TDF.

In one embodiment, the TDF of the encapsulating agent is between 70%-100% TDF.

In another embodiment, the TDF of the encapsulating agent is between about 70%-about 100% TDF.

In one embodiment, the TDF of the encapsulating agent is between 80%-100% TDF.

In another embodiment, the TDF of the encapsulating agent is between about 80%-about 100% TDF.

### Mixtures Comprising Non-Digestible Carbohydrates

In one embodiment a mixture comprising a non-digestible carbohydrate is comprised of at least one component having a DP of less than 13; wherein the at least one non-digestible carbohydrate component of the mixture having a DP of less than 13 is at least 3% w/w of the mixture.

In another embodiment a mixture comprising a non-digestible carbohydrate is comprised of at least one component having a DP of less than 13; wherein the at least one non-digestible carbohydrate component of the mixture having a DP of less than 13 is at least about 3% w/w of the mixture.

In one embodiment a mixture comprising a non-digestible carbohydrate is comprised of at least one component having a DP of less than 13; wherein the at least one non-digestible carbohydrate component of the mixture having a DP of less than 13 is at least 6% w/w of the mixture.

In one embodiment a mixture comprising a non-digestible carbohydrate is comprised of at least one component having a DP of less than 13; wherein the at least one non-digestible carbohydrate component of the mixture having a DP of less than 13 is at least about 6% w/w of the mixture.

In one embodiment a mixture comprising a non-digestible carbohydrate is comprised of at least one component having a DP of less than 13; wherein the at least one non-digestible carbohydrate component of the mixture having a DP of less than 13 is at least 10% w/w of the mixture.

In one embodiment a mixture comprising a non-digestible carbohydrate is comprised of at least one component having a DP of less than 13; wherein the at least one non-digestible carbohydrate component of the mixture having a DP of less than 13 is at least about 10% w/w of the mixture.

In another embodiment a mixture comprising a non-digestible carbohydrate is comprised of a polyol.

In another embodiment any non-digestible carbohydrate components may be used in any ratio so as to form a mixture comprising a non-digestible carbohydrate, so long as the DP of the mixture is less than 13.

### Encapsulating Agent

The term “encapsulating agent”, as used herein, is intended to mean a composition that, when prepared in an emulsion with an active agent and subsequently dried results in either (a) a micro-encapsulated active agent, or (b) a coated active agent.

In one embodiment, the subsequent drying utilized in the encapsulating process may be any type of drying known in the art. Suitable examples of such drying include but are not limited to fluid bed drying; freeze drying; drum drying; and spray drying.

In one embodiment, an encapsulating agent is comprised of a gum arabic (i.e., an emulsifier) and a non-digestible carbohydrate with a DP of less than 13 or a mixture with at least component of the mixture having a DP of less than 13 In one specific example, the encapsulating agent is comprised of gum arabic and a polyol.

In another embodiment, the emulsifier is present in a w/w percentage of 0.5 to 40%, in one embodiment 0.5% to 25% of the encapsulating agent.

The following are illustrative examples of the encapsulating agent of the present invention:

| Example | 1 | 3 | 4 | 5 | 6 | 7 | 8 | 9 | 11 |
|---|---|---|---|---|---|---|---|---|---|
| Gum Arabic (g) | | 58 | | | | | | | |
| NUTRIOSE ® (g) | 54 | | 81 | 81 | 81 | 81 | | | |
| FIBERSOL ® (g) | | | | | | | 99 | | |
| LITESSE II ® (g) | | | | | | | | 99 | |
| Nutra Flora ® (g) | | | | | | | | | 99 |
| Maltitol (g) | | | 27.7 | | | | | | |
| Xylitol (g) | | | | 18 | | | | | |
| Mannitol (g) | | | | | 18 | | | | |
| Sorbitol (g) | 12 | 12 | | | | 18 | | | |
| Quillaja | 4 | | 6 | 6 | 6 | 6 | 6 | 6 | 6 |
| emulsifier | | | | | | | | | |

### Use And Active Agents

The encapsulating agent may be used to encapsulate any active agent and in one embodiment is used to encapsulate an oxygen sensitive active agent. Oxygen sensitive agents are intended to include, without limitation, unsaturated fatty acids such as gamma-linolenic acids, citrus oils such as orange oils, vitamins such as Vitamin A, Vitamin E, and Vitamin D, tocopherols, tocotrienols, phytosterols, Vitamin K, beta-carotene, marine oils, and omega-3 fatty acids. In a further embodiment, the encapsulating agent is used to encapsulate marine oil or omega-3 fatty acids, including concentrated omega-3 fatty acids.

The active agent may be any substance which will not react with the encapsulating agent, including but not limited to oils, fats, flavors, colors, fragrances, vitamins, and pharmaceuticals. In particular, the encapsulating agent of the present invention is useful for emulsifying or encapsulating oil-based active agents. These oils may be volatile or non-volatile and are generally characterized by being essentially water immiscible in water in the presence of an encapsulating agent.

The active agents may be encapsulated using the encapsulating agents of the present invention and techniques known in the art. In one embodiment, the encapsulating agent may be dispersed in water, the active agent may be added and emulsified, and the emulsion may then be dried to form the encapsulated product. Drying may be accomplished by any appropriate method known in the art, including but not limited to spray drying, extrusion, spray chilling, and fluid bed coating. In one embodiment, the active agent is homogenized (emulsified) in a solution/dispersion of the encapsulating agent and then spray dried. Emulsification and drying conditions may be controlled by one skilled in the art to yield encapsulated product with the desired attributes. For example, if volatile or heat labile active agents are used, relatively low temperatures will be used to reduce loss and/or inactivation of the active agent. One skilled in the art may also vary the average particle size of the emulsion to obtain the desired results. In one embodiment, the particle size of the emulsion is about one micron.

The resultant encapsulated products are, in one embodiment, in the form of a dry, free-flowing powder. These products have the advantage of achieving and maintaining consistently high active agent levels, and/or excellent oxidation resistance.

The encapsulated product prepared with the present encapsulating agents consistently achieves and maintains a relatively high level of the active agent. The active agent may be present in an amount of from about 5 to 70% (wt/wt) based upon the final encapsulated product. (i.e., post-drying). In another embodiment, the active agent is present in an amount of from about 15 to 60% (wt/wt).

A high level of active agent is desirable to reduce the cost of producing the final product as encapsulating agents are often expensive. Further, some encapsulating agents may contribute adverse or undesirable properties to the final system and it is thus desirable to reduce the amount of encapsulating agent used.

In one embodiment, a high level of active agent is achieved. In another embodiment, a longer shelf life is achieved. The present encapsulating agents also retain the oil so as to provide a low amount of surface oil. The surface oil may be measured by methods known in the art such as by washing the encapsulated powder with a suitable solvent. Reduction of surface oil may be beneficial as increased surface oil indicates that the load of the active agent is not being maintained (instability) and inefficiency of encapsulation. Thus, reduction of surface oil results in a longer shelf life.

In one embodiment, the oil load is 30% (30% oil load is used for all experiments unless otherwise specified), the total oil retention is at least 20%. In another embodiment, the total oil retention is at least 25%.

The present encapsulating agents also provide a relatively high level of oxidation resistance, thereby prolonging storage stability of the encapsulated product and shelf life of the final product. Oxidation resistance may be measured by methods known in the art. Oxidation resistance may be beneficial not only for flavor considerations of the oil, but also to maintain the activity of various products. To further increase oxidation resistance, an anti-oxidant and/or reducing agent may be added to the oil. In one embodiment, the maximum ppm oxidative components is 1600. In another embodiment, the maximum ppm oxidative components is at least about 1600. In one embodiment, the oil load is at least 20%. In another embodiment, the oil load is at least about 20%. In another embodiment, the oil load is at least 25%. In another embodiment, the oil load is at least about 25%. In another embodiment, the oil load is at least 30%. In another embodiment, the oil load is at least about 30%.

In one embodiment, the encapsulated product is stable when stored as a powder and releases the active agent upon exposure to moisture. The resultant encapsulated product may be used at any level desired, the amount being dependent upon the amount of active agent to be incorporated and the product in which it is to be used. In one embodiment in which the encapsulated products are used in a food product, the encapsulated product is used in an amount of from about 0.01 to about 10% by weight of the food product and in another embodiment up to about 5% (wt/wt).

The resultant encapsulated product may be used in various food products including, but not limited to, cereals; powdered drink mixes; instant coffees and teas; powdered sauce and gravy mixes; instant soups; powdered dressings; bakery products including breads and bread products; intermediate moisture foods including shelf stable nutrition bars; flavors; fragrances; colorants; and other dry food products. Upon preparation of powdered and instant products, the moisture triggers the release mechanism, providing the active agent to the consumer.

The resultant encapsulated product may also be used in a variety of pharmaceuticals including vitamins; personal care products including antiperspirants, deodorants, soaps, fragrances, and cosmetics; hair care products, such as hair sprays, mousses, shampoos, cream rinses, and gels; paper products such as diapers, sanitary napkins, paper towels, tissues, toilet tissues; animal care products such as kitty litter; and household products such as carpet cleaners, and air fresheners.

### Oil-In-Water Emulsion

In another embodiment, the encapsulating agent is substantially sugar-free. In still yet another embodiment, the encapsulating agent contains no sugar.

In another embodiment the Brookfield viscosity of a water-in-oil emulsion containing the encapsulating agent is less than 400 cps when tested in the water-in-oil emulsion of Example 1.

In another embodiment the Brookfield viscosity of a water-in-oil emulsion containing the encapsulating agent is less than about 400 cps when tested in the water-in-oil emulsion of Example 1.

In another embodiment the Brookfield viscosity of the test water-in-oil emulsion is less than 300 cps when tested in the water-in-oil emulsion of Example 1/

In another embodiment the Brookfield viscosity of a water-in-oil emulsion containing the encapsulating agent is less than about 300 cps when tested in the water-in-oil emulsion of Example 1.

In another embodiment the Brookfield viscosity of the test water-in-oil emulsion is less than 200 cps when tested in the water-in-oil emulsion of Example 1.

In another embodiment the Brookfield viscosity of a water-in-oil emulsion containing the encapsulating agent is less than about 200 cps when tested in the water-in-oil emulsion of Example 1.

In another embodiment the Brookfield viscosity of the test water-in-oil emulsion is less than 150 cps when tested in the water-in-oil emulsion of Example 1.

In another embodiment the Brookfield viscosity of a water-in-oil emulsion containing the encapsulating agent is less than about 150 cps when tested in the water-in-oil emulsion of Example 1.

In another embodiment the Brookfield viscosity of the test water-in-oil emulsion is less than 100 cps when tested in the water-in-oil emulsion of Example 1.

In another embodiment the Brookfield viscosity of the test water-in-oil emulsion is less than about 100 cps when tested in the water-in-oil emulsion of Example 1.

In another embodiment the Brookfield viscosity of the test water-in-oil emulsion is less than 75 cps when tested in the water-in-oil emulsion of Example 1.

In another embodiment the Brookfield viscosity of the test water-in-oil emulsion is less than about 75 cps when tested in the water-in-oil emulsion of Example 1.

In another embodiment, the encapsulating agent results in less than 1800 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than about 1800 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than 1600 ppm aged oxidation components when tested in a sample encapsulation of 30% w/w orange oil 1× for 14 days at 50° C., in accordance with the procedures described in Examples 1, 2, and 5.

In another embodiment, the encapsulating agent results in less than about 1600 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than 1400 ppm aged oxidation components when tested in a sample encapsulation of 30% w/w orange oil 1× for 14 days at 50° C., in accordance with the procedures described in Examples 1, 2, and 5.

In another embodiment, the encapsulating agent results in less than about 1400 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than 1200 ppm aged oxidation components when tested in a sample encapsulation of 30% w/w orange oil 1× for 14 days at 50° C., in accordance with the procedures described in Examples 1, 2, and 5.

In another embodiment, the encapsulating agent results in less than about 1200 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than 1000 ppm aged oxidation components when tested in a sample encapsulation of 30% w/w orange oil 1× for 14 days at 50° C., in accordance with the procedures described in Examples 1, 2, and 5.

In another embodiment, the encapsulating agent results in less than about 1000 ppm oxidation components when tested in a sample encapsulation of 30% w/w orange oil 1× for 14 days at 50° C., in accordance with the procedures described in Examples 1, 2, and 5.

In another embodiment, the encapsulating agent results in less than 800 ppm aged oxidation components when tested in a sample encapsulation of 30% w/w orange oil 1× for 14 days at 50° C., in accordance with the procedures described in Examples 1, 2, and 5.

In another embodiment, the encapsulating agent results in less than about 800 ppm oxidation components when tested in a sample encapsulation of 30% w/w orange oil 1× for 14 days at 50° C., in accordance with the procedures described in Examples 1, 2, and 5.

In another embodiment, an encapsulated product comprises an encapsulating agent; and an active agent.

In another embodiment, an encapsulated product comprises

a matrix comprising the encapsulating agent of claim 1; and

an active agent.

In another embodiment, an oil-in-water emulsion is described comprising:

a. a water-containing continuous phase;

b. an active agent-containing discrete phase; and

c. the encapsulating agent of claim 1.

### EXAMPLES

The following examples are presented to further illustrate and explain the present invention and should not be taken as limiting in any regard. All ratios, parts and percentages are given by weight and all temperatures in degrees Celsius (° C.) unless otherwise noted.

The following materials were used throughout the examples.

Q-NATURALE® 200 emulsifier, a liquid quillaja extract which contains about 21% quillaja solid extract and 14% active saponin, commercially available from National Starch LLC (Bridgewater, N.J.)

Orange oil 1× with a density of 0.84 g/ml, commercially available from Givaudan (Cincinati, Ohio)

Gum Arabic an emulsifier commercially available from Colloid Natural Inc., (CNI) (France)

Sorbitol: Sorber Gem 006, commercially available from Corn Products International (Westchester, Ill.)

Mannitol, commercially available from Corn Products International (Chicago, Ill.)

Maltitol, commercially available from Corn Products International (Chicago, Ill.)

Xylitol, commercially available from Nutraceutical Corp. (Park City, Utah) Nutra Flora, commercially available from GTC Nutrition (Golden, Colo.)

LITESSE II, commercially available from Danisco USA, Inc. (Terre Haute, Ind.)

Fiber Sol, commercially available from ADM (Decatur, Ill.)

NUTRIOSE FM06, commercially available from Roquette Freres S.A. (Lestrem, France)

A summary table is provided below:

| | Name | Supplier | Location |
|---|---|---|---|
| Polyol | | | |
| Sorbitol | Sorber Gem 006 | Corn Products | Westchester, IL |
| | | International | |
| Mannitol | Mannite/Manna | Corn Products | Newark, DE |
| | sugar | Specialty | |
| | | Ingredients | |
| Maltitol | Maltisorb/ | Corn Products | Newark, DE |
| | Maltisweet | Specialty | |
| | | Ingredients | |
| Xylitol | D-Xylitol | Nutraceutical | Park City, UT |
| | | Corp | |
| Non-digestible | | | |
| carbohydrate | | | |
| Nutra Flora | NutraFlora P-95 | GTC Nutrition | Golden, CO |
| LITESSE II | Polydextrose | Danisco Usa Inc | Terre Haute, IN |
| FIBERSOL | FIBERSOL ® 2 | ADM | Decatur, IL |
| NUTRIOSE | NUTRIOSE ® | Roquette Freres | Lestrem, France |
| | FM06 | S.A | |

### Example 1

### Preparation of Spray Drying Emulsion Containing Orange Oil

Spray drying Orange Oil emulsions were prepared as follows:

### Formula I: Standard Orange Oil Emulsion Utilizing Flavor Oil Composition

| Ingredients | |
|---|---|
| Orange Oil 1X | 10%-20% |
| Polyol | 0%-25% |
| Emulsifier | 0.15%-30% |
| NDC | 10%-40% |
| Water | 50.0% |

The water phase was prepared by dissolving the required amounts of polyol in water. Non-digestible carbohydrate was dissolved in the above solution. Emulsifier was dispersed with moderate agitation. A spray drying emulsion was made by slowly adding the oil to the water phase using an LCI high shear mixer (Model HSM-100 LCI from Charles Ross & Son Company) at 7500 rpm for 2 minutes and then at 10000 rpm for 3 minutes. The particle size and viscosity of the emulsion was then checked.

### Example 2

### Procedure For Orange Oil Encapsulation Using Spray Drying Method

The prepared emulsion was spray dried using a Niro Utility Spray Drier #3-068 with a centrifugal atomizer installed. The inlet temperature was approximately from 165-180 degrees C., and the outlet temperature was from 75 to 90 degrees C. The flow rate was kept at about 150-400 ml/min.

### Example 3

### Procedure for Measurement of Emulsion Particle Size

Emulsion particle sizes were measured using the LS13 320, manufactured by Beckman Coulter and incorporating Polarization Intensity Differential Screening technology together with a sophisticated software package to provide a dynamic range of particle size measurement capabilities between 0.04 μm to 2000 μm.

From the pull down manual of the software, a sample ID was entered and the appropriate optical module was selected to be used for the system to be measured. A sequence of steps automatically followed: Measuring offsets; Alignment; Background measurement; Measure loading. The instrument sounded a bell and displayed Measuring Loading when ready to accept a sample.

A diluted sample was introduced by drops into the sample reservoir and changes in the Measure Loading were observed. This function measured the amount of light scattered out of the beam by the particles so as to determine an appropriate concentration of sample. When sizing particles without using PIDS an obscuration level of 8% to 12% is appropriate. When PIDS is used, a PIDS obscuration of 40% to 60% is recommended. A real part of index of refraction of 1.5 was used.

Analysis then followed. The pull-down menu allowed the user to print the results and related graphs either to the inline printer or to a PDF file.

### Example 4

### Procedure for Measurement of Emulsion Viscosity

Viscosity measurements were performed with the Brookfield Programmable DV-I Viscometer at a given measurement conditions (spindle S63 @ 60 rpm & 15 sec). The principal of operation of the DV-I is to drive or rotate a spindle (which is immersed in the test fluid) through a calibrated spring. The viscous drag of the fluid against the spindle is measured by the spring deflection. Spring deflection is measured with a rotary transducer which translates the drag into viscosity of the test fluid through an internal calibration. The measurement range (in centipoises or milliPascal seconds) is determined by the rotational speed of the spindle, the size and shape of the spindle, the container the spindle is rotating in, and the full scale torque of the calibrated spring. Viscosity measurements were made on a 22° C. sample contained in an 8 ounce tall glass fluid container having dimensions of 2.25″ width×5″ height. The Viscometer was leveled and warmed up for ˜10 minutes. The selected spindle was rotated through the sample of interest for a predetermined time period (15 seconds).

The viscosity of the test fluid was displayed in centipoises.

The Viscometer was leveled and warmed up for ˜10 minutes. The selected spindle is rotated through the sample of interest for a predetermined time period (15 second run time). Viscosity of the test fluid is displayed in centipoises.

### Example 5

### Procedure for Oxidation Components Analysis

The samples were analyzed by static Headspace GC/MS versus an external calibration curve for oxidized Orange oil components of Limonene Oxide, Carvone, and Carvoel. The results were recorded in ppm. The total oxidation components mentioned through out the examples was the sum of Limonene Oxide, Carvone and Carvoel.

Headspace Conditions—Samples were thermo-stated at 85° C. for 25 minutes prior to injection of the Headspace vapors. The GC/MS system for the analysis is described below:
Thermo DSQ II GC/MS
Column—30 m.×0.25 mm ID RTX-VGC (1.4 um film)
Helium Carrier—1 mL/min.—constant flow
Oven—35° C. for 4.0 min.; 4° C./min. to 75° C. for 2.0 min.; 20° C./min to 175° C.; 35° C./min to 210° C.; hold 3 min.
Injection Port Temperature −250° C.

Detector Temperature −250° C.

### Example 6

### Procedure for Orange Oil Retention Analysis

The samples were analyzed for % total oil retention by direct injection—GC/FID versus an external Calibration curve. The GC system for the analysis is described below:

### Hewlett-Packard 7890A GC

Column—30 m.×0.53 mm ID Stabilwax-DA (1.5 um film)
Helium Carrier—20 mL/min.—constant flow
Oven—50° C. for 2.0 min.; 10° C./min. to 225° C.; hold 10.5 min. (30 min. run)

### Injection Port Temp. −200° C.

### Detector Temp. −275° C.

1 uL direct injections—HP 7683 autosampler
The results were based upon duplicate injections of a single sample preparation. Calibration was done based upon a four point standard calibration curve of Orange oil.

### Example 7

### Comparison of Oil Retention and Oxidation Components for Matrices with and without Polyol

The following samples were prepared and spray dried followed the spray drying emulsion preparation procedure and the spray drying procedure. The analytical results of oil retention and oxidation components at day 0 and day 14 after aging in 50 degrees C. oven are also shown as below:

| ELN SM 00084612 | Sample 1 | Sample 2 | Sample 3 |
|---|---|---|---|
| Orange oil 1X (g) | 30 | 30 | 30 |
| Gum Arabic (g) | | 70 | 58 |
| Q-Natural 200 (g) | 4 | | |
| NUTRIOSE (g) | 54 | | |
| Sorbitol (g) | 12 | | 12 |
| Water (g) | 100 | 233.3 | 100 |
| Total (g) | 200 | 333.3 | 200 |
| Total oil retention (%) - day 0 | 29.69 | 16.7 | 26.4 |
| Aged oxidation components | 1208 ppm | 1931 ppm | 865 ppm |
| (ppm) | | | |
| Viscosity (cps) | 34 | 900 | 324 |
| Emulsion particle size (microns) | 0.6 | 1.954 | 1.244 |
| Oil Load | 30% | 30% | 30% |

Higher oil retention percentage and lower total oxidation components indicate better encapsulation performance. The encapsulation performance of matrices SF322104A and SF32210E, which contained sorbitol, were better compared to SF322104B which contained no sorbitol. Oil retention percentage measured at day 0 for SF 322104A and SF32210E were much higher and much less oxidation components existed in mentioned matrices as well.

Emulsion particle size of less than 1.5 micron was desired to obtain a good encapsulation performance. In another embodiment, emulsion particle size of less than 1.2 micron was desired to obtain a good encapsulation performance. Also, the viscosity of the emulsion of less 500 cps at 50% solids, while Orange oil 1× is considered as part of the total solids, was considered as optimum condition for ease of processing and cost effective resulting from less drying time and energy.

Matrices SF322104 A and SF32210E, which contained sorbitol, had much lower emulsion viscosity and emulsion particle compared to SF322104B which contained no sorbitol. This indicated that the addition of sorbitol helped with encapsulation processing and cost optimization.

### Example 8

### Comparison of Oil Retention and Oxidation Components for Matrices Containing Different Types of Polyol

The following samples were prepared and spray dried followed the spray drying emulsion preparation procedure and the spray drying procedure. The analytical results of oil retention at day 0 and total oxidation components at day 14 after aging in 50 degrees C. oven are also shown as below:

| Test | Sample 4 | Sample 5 | Sample 6 | Sample 7 |
|---|---|---|---|---|
| Q-Naturale | 6 | 6 | 6 | 6 |
| 200 (g) | | | | |
| Maltitol (g) | 27.7 | | | |
| Xylitol (g) | | 18 | | |
| Sorbitol (g) | | | | 18 |
| Mannitol (g) | | | 18 | |
| NUTRIOSE (g) | 81.0 | 81 | 81 | 81 |
| orange oil | 45.0 | 45 | 45 | 45 |
| 1X (g) | | | | |
| Water (g) | 150 | 150 | 150 | 150 |
| Total (g) | 300 | 300 | 300 | 300 |
| Particle size | 1.091 | 0.896 | 1.001 | 0.866 |
| (microns) | | | | |
| Viscosity (cps) | 30.5 | 35 | 43 | 33 |
| Total oil | 26.94 | 29.41 | 28.85 | 27.86 |
| retention | | | | |
| (%) - day 0 | | | | |
| Aged - total | 1771 | 1780 | 1640 | 1642 |
| oxidation | | | | |
| components | | | | |
| (ppm) | | | | |
| Oil Load | 30% | 30% | 30% | 30% |

All tested polyol types yielded similar encapsulation performance of oil retention and total oxidation components. Emulsion particle size and viscosity results were similar as well.

### Example 9

### Comparison of Oil Retention and Oxidation Components for Matrices Containing Different Types of Non-Digestible Carbohydrate

The following samples were prepared and spray dried followed the spray drying emulsion preparation procedure and the spray drying procedure. The analytical results of oil retention at day 0 and total oxidation components at day 14 after aging in 50 degrees C. oven are also shown as below:

| | Sample 8 | Sample 9 | Sample 10 | Sample 11 |
|---|---|---|---|---|
| Q-Naturale | 6 | 6 | 6 | 6 |
| 200 (g) | | | | |
| FIBERSOL (g) | 99 | | | |
| LITESSE II (g) | | 99 | | |
| NUTRIOSE | | | 99 | |
| FM06 (g) | | | | |
| Nutra Flora (g) | | | | 99 |
| Orange oil | 45 | 45 | 45 | 45 |
| 1X (g) | | | | |
| Water (g) | 150 | 150 | 150 | 150 |
| Total (g) | 300 | 300 | 300 | 300 |
| Particle size | 0.84 | 1.072 | 0.866 | 1.244 |
| (microns) | | | | |
| Viscosity (cps) | 35 | 25 | 39 | 21 |
| Total oil | 27.55 | 29.87 | 27.6 | 29.56 |
| retention | | | | |
| (%) - day 0 | | | | |
| Aged - | 1703 | 874 | 1960 | 731 |
| oxidation | | | | |
| components | | | | |
| (ppm) | | | | |
| Oil Load | 30% | 30% | 30% | 30% |

While a number of embodiments of the present invention have been described, it is understood that these embodiments are illustrative only, and not restrictive, and that many modifications and/or alternative embodiments may become apparent to those of ordinary skill in the art. For example, any steps may be performed in any desired order (and any desired steps may be added and/or any desired steps may be deleted). Therefore, it will be understood that the appended claims are intended to cover all such modifications and embodiments that come within the spirit and scope of the present invention.

What is claimed is:

1. An encapsulating agent comprising
an emulsifier; and
a non-digestible carbohydrate
wherein the non-digestible carbohydrate is selected from the group consisting of
a. a non-digestible carbohydrate with a DP less than 13; or
b. a mixture comprising two or more non-digestible carbohydrates,
wherein at least one non-digestible carbohydrate component of the mixture has a DP of less than 13; and
wherein the at least one non-digestible carbohydrate component of the mixture having a DP of less than 13 is at least 5% w/w of the mixture; and
wherein the encapsulating agent results in less than 1800 ppm oxidized components when tested in a sample encapsulation of 30% w/w orange oil 1× for 14 days at 50° C.

2. The encapsulating agent of claim 1,
wherein an oil-in-water emulsion of the encapsulating agent results in a Brookfield viscosity less than 150 cps at 50% solids at 22° C. when tested in a sample oil-in-water emulsion consisting of:
a. 15% w/w orange oil 1×;
b. 35% w/w of the encapsulating agent utilized as an emulsifier, wherein the encapsulating agent utilized as an emulsifier comprises
1. 29% of the emulsifier, and
2. 6% of the non-digestible carbohydrate, and
c. 50.0% w/w water.

3. The encapsulating agent of claim 1 or 2, wherein the average DP of the encapsulating agent is at least 3.

4. The encapsulating agent of any of claims 1-3, wherein the emulsifier of the encapsulating agent utilized as the emulsifier is Q-NATURALE®. emulsifier

5. The encapsulating agent of any of claims 1-4, wherein the encapsulating agent has a TDF of 60-100%.

6. The encapsulating agent of claim 5, wherein the at least one non-digestible carbohydrate component of the encapsulating agent having 60-100% TDF is further characterized as having a DP of less than 100.

7. The encapsulating agent of any of claims 1-6, wherein the emulsifier is selected from the group consisting of gum ghatti, pectin, gum arabic, modified cellulosics, lecithin, arabinogalactan, proteins, saponin, quilaja, quillaja solid extract, and/or quillaic acid, polysorbates, and sugar esters.

8. The encapsulating agent of any of claims 1-7, wherein the non-digestible carbohydrate is selected from the group consisting of gum arabic; polydextrose; short chain fructose oligosaccharide; and resistant maltodextrins.

9. The encapsulating agent of claim 8, wherein the resistant maltodextrin is selected from the group consisting of fibersol and nutriose.

10. The encapsulating agent of any of claims 1-10, wherein the non-digestible carbohydrate is further comprised of a polyol.

11. The encapsulating agent of claim 10, wherein the polyol is selected from the group consisting of erythtirol; hydrogenated starch hydrosylates; hydrogenated starch polyglycitols; isomalt; lactitol; maltitol; mannitol; sorbitol; and xylitol.

12. The encapsulating agent of any of claims 1-11, wherein the emulsifier is substantially sugar free.

13. The encapsulating agent of any of claim 1 or 3-12, wherein the emulsifier is gum arabic.

14. The encapsulating agent of any of claims 1-12, wherein the emulsifier is a saponin.

15. The encapsulating agent of claim 14, wherein the saponin is a Quillaja solid extract.

16. The encapsulating agent of any one of claims 1-15, wherein the non-digestible carbohydrate is selected from the group consisting of resistant maltodextrin, polydextrose, and short chain fructose oligosaccharides.

17. The encapsulating agent of any of claims 1-3, 5-7, and 12-15, wherein the mixture comprising two or more non-digestible carbohydrates is comprised of Gum Arabic and sorbitol.

18. The encapsulating agent of any of claims 1-3, 5-7, and 12-15, wherein the mixture comprising two or more non-digestible carbohydrates is comprised of nutriose and sorbitol.

19. The encapsulating agent of any of claims 1-3, 5-7, and 12-15, wherein the mixture comprising two or more non-digestible carbohydrates is comprised of nutriose and maltitol.

20. The encapsulating agent of any of claims 1-3, 5-7, and 12-15, wherein the mixture comprising two or more non-digestible carbohydrates is comprised of nutriose and xylitol.

21. The encapsulating agent of any of claims 1-3, 5-7, and 12-15, wherein the mixture comprising two or more non-digestible carbohydrates is comprised of nutriose and mannitol.

22. The encapsulating agent of any of claims 1-3, 5-7, and 12-15, wherein the mixture comprising two or more non-digestible carbohydrates is comprised of nutriose and sorbitol.

23. The encapsulating agent of any of claims 1 and 3-22, wherein the emulsifier is present in a w/w percentage of 0.5-40 of the encapsulating agent.

24. The encapsulating agent of any of claims 1 and 3-23, wherein the non-digestible carbohydrate is present in a w/w percentage of 60-99.5 of the encapsulating agent.

25. An encapsulated product comprising
(a) the encapsulating agent of any of claims 1-24; and
(b) an active agent.

26. The encapsulated product of claim 25,
wherein the encapsulated product is at least 30% w/w active agent.

27. An encapsulated product comprising:
(1) a matrix comprising the encapsulating agent of any of claims 1-14; and
(2) an active agent.

28. A food product comprising:
the encapsulating agent of any of claims 1-24; and
an active agent.

29. An oil-in-water emulsion comprising:
a. a water-containing continuous phase;
b. an active agent-containing discrete phase; and
c. the encapsulating agent of any of claims 1-24.
